(19) United States
(12) Patent Application Publication
(10) Pub. No.: US 2015/0169161 A1
(43) Pub. Date: Jun. 18, 2015

(54) METHOD AND APPARATUS FOR SCROLLING CONTROL IN MOBILE TERMINAL

(71) Applicant: Samsung Electronics Co., Ltd., Gyeonggi-do (KR)

(72) Inventor: Byoungseoup MOON, Gyeonggi-do (KR)

(73) Assignee: Samsung Electronics Co., Ltd.

(21) Appl. No.: 14/575,181

(22) Filed: Dec. 18, 2014

(30) Foreign Application Priority Data
Dec. 18, 2013 (KR) 10-2013-0157770

(51) Int. Cl. G06F 3/0485

(52) U.S. Cl. CPC G06F 3/0485

(57) ABSTRACT

Provided are a method and apparatus for scrolling control in a mobile terminal. The scrolling control method includes displaying the screen, measuring, when a first scroll action and a second scroll action are detected in succession on the screen, time difference between the first scroll action and second scroll action, determining successive scroll actions when the time difference is less than or equal to a preset threshold time, and performing, upon determination of successive scroll actions, automatic scrolling by displaying the screen while scrolling the screen.

### PRIORITY

This application claims priority under 35 U.S.C. § 119(a) to a Korean Patent Application filed on Dec. 18, 2013 in the Korean Intellectual Property Office and assigned Ser. No. 10-2013-0157770, the entire disclosure of which is hereby incorporated by reference.

### BACKGROUND OF THE INVENTION

1. Field of the Invention

The present invention relates generally to a method and apparatus for controlling successive scrolling on the screen of a mobile terminal.

2. Description of the Related Art

A mobile terminal equipped with a touch panel uses the touch panel as an input means. Such a mobile terminal may detect various input events and perform corresponding functions.

A mobile terminal displays pages or images of various applications such as a browser, electronic book and gallery on the screen and detect a scroll event to control scrolling on the screen. The mobile terminal may scroll and display the screen according to the scroll event. Scrolling corresponds to horizontally or vertically sliding text, images or video on the screen.

For example, when a scroll event is detected during execution of a gallery application with many photographs, the mobile terminal may scroll the photographs one screenful at a time. As another example, the mobile terminal may provide a slide show function during execution of the gallery application. When an icon associated with the slide show function is selected, the slide show function may be initiated to thereby scroll the photographs so that one photograph at a time is displayed for a preset duration.

In general, when a scroll event is detected, the mobile terminal scrolls the screen in a direction corresponding to the direction of the scroll event. To control scrolling during execution of an application with many pages (e.g., browser, electronic book or gallery application), the user may have to repeatedly generate a scroll event. To address this inconvenience, some applications such as a gallery application, provide a slide show function. However, the slide show function displays one screenful of information at a time for a preset duration without regard to a user's comprehension. Hence, the user may have to inconveniently reconfigure the time setting for the slide show function each time the user views a slide show.

### SUMMARY OF THE INVENTION

Aspects of the present invention are to address at least the above mentioned problems and/or disadvantages and to provide at least the advantages described below.

Accordingly, an aspect of the present invention is to provide a method and apparatus that sense successive scroll actions and perform automatic scrolling according to the sensed scroll actions in a mobile terminal.

Another aspect of the present invention is to provide a method and apparatus that enable a mobile terminal to reduce the number of touch inputs needed through automatic scrolling.

Another aspect of the present invention is to provide a method that, when scroll events are successively generated by the user, enables a mobile terminal to perform successive scrolling in consideration of the movement direction and speed of scroll events and the time interval between scroll events.

In accordance with an aspect of the present invention, a scrolling control method for a mobile terminal includes displaying the screen, measuring, when a first scroll action and a second scroll action are detected in succession on the screen, time difference between the first scroll action and second scroll action, determining successive scroll actions when the time difference is less than or equal to a preset threshold time, and performing, upon determination of successive scroll actions, automatic scrolling by displaying the screen while scrolling the screen.

In accordance with another aspect of the present invention, a scrolling control apparatus for a mobile terminal includes a display panel that displays screen data, a touch panel that detects a first scroll action and a second scroll action in succession on the screen, and a control unit that controls a process of measuring time difference between the first scroll action and second scroll action, determining that the first scroll action and the second scroll action are successive scroll actions when the time difference is less than or equal to a preset threshold time, and performing, upon determination of successive scroll actions, automatic scrolling by displaying the screen while scrolling the screen.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 illustrates a mobile terminal according to an embodiment of the present invention;

FIGS. 2A and 2B are flowcharts illustrating a procedure for automatic scrolling in a mobile terminal according to an embodiment of the present invention;

FIGS. 3A, 3B and 3C illustrate automatic scrolling in the mobile terminal according to the procedure of FIGS. 2A and 2B;

FIG. 4 is a flowchart illustrating a procedure for automatic scrolling in a mobile terminal according to an embodiment of the present invention;

FIG. 5 illustrates automatic scrolling in a mobile terminal according to the procedure of FIG. 4; and

FIGS. 6A and 6B are flowcharts illustrating a procedure for automatic scrolling in the mobile terminal according to an embodiment of the present invention.

### DETAILED DESCRIPTION OF EMBODIMENTS OF THE INVENTION

Embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring the subject matter of the present invention.

According to embodiments of the present invention, the word “screen” refers to the window displayed by a mobile terminal. For example, the screen may be associated with a gallery, electronic document, electronic book, email, message, list (e.g., a list of friends, emails, messages, or photographs), or web browser. The screen data may be composed of multiple pages or images. In this case, one screen may correspond to one screenful of information or data displayed at a time, such as a page. As a mobile terminal may not be equipped to display multiple pages or images on the screen simultaneously, scrolling is used to view a desired page or image. In the flowing description, the screen is assumed to be associated with screen data of a gallery application currently being executed.

The term “successive scroll actions” refers to two or more scroll actions that are performed in succession so that the time difference therebetween is less than a given threshold time. The user may perform a scroll action by making a touch gesture involving touch-down, drag and touch-up on the touch panel.

The term “automatic scrolling” refers to a display feature that automatically scrolls the screen of the mobile terminal when successive scroll actions are detected. For example, assuming that a first scroll action and a second scroll action are detected and the time difference therebetween is less than the threshold time, the first and second scroll actions are regarded as successive scroll actions, which initiates automatic scrolling. The “threshold time” is a time value used to determine whether two scroll actions are successive scroll actions. That is, if the second scroll action is detected within the threshold time after detection of the first scroll action, the first and second scroll actions are regarded as successive scroll actions, initiating automatic scrolling. If the second scroll action is detected but not within the threshold time after detection of the first scroll action, the first and second scroll actions are processed as independent scroll actions.

When successive scroll actions are detected, the mobile terminal may compute the scrolling speed for automatic scrolling. In a first scheme, the scrolling speed may be determined on the basis of the time difference between the first scroll action and the second scroll action. For example, first, second and third scrolling speeds may be set respectively to 1 second, 2 seconds and 3 seconds, within the threshold time (e.g., 5 seconds). The scrolling speed based on the time difference may be set by default or by the user.

In a second scheme, the scrolling speed may be determined on the basis of the movement distance and movement time of the first scroll action and second scroll action. For example, the scrolling speed may be determined using movement distance L1 and movement time T1 of the first scroll action. The scrolling speed may also be determined using movement distance L2 and movement time T2 of the second scroll action. The scrolling speed may further be determined using the average of movement distances L1 and L2 and the average of movement times T1 and T2.

In addition, the scrolling speed for automatic scrolling may be computed according to a combination of the first scheme and second scheme, or in various other manners.

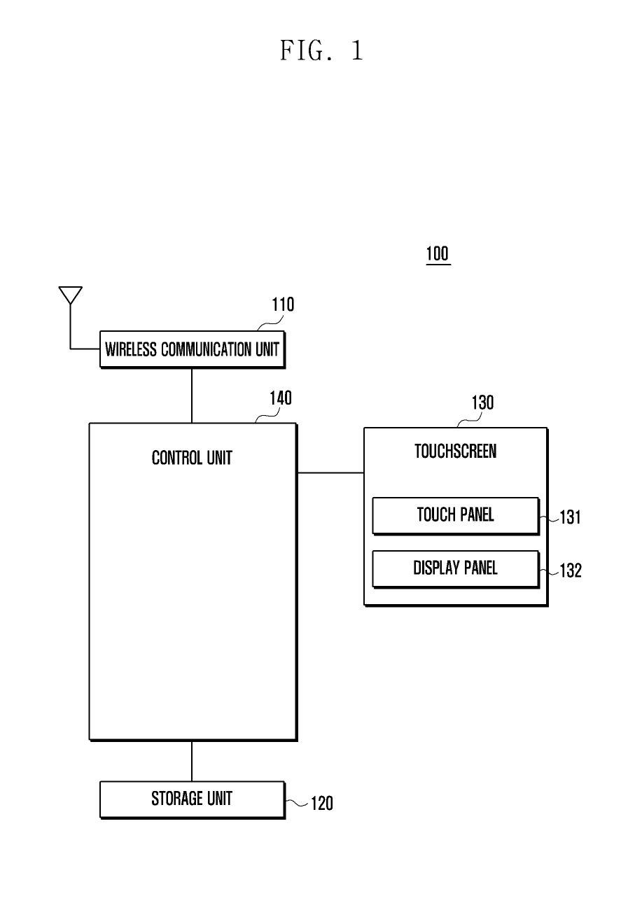

FIG. 1 illustrates a mobile terminal 100 according to an embodiment of the present invention.

Referring to FIG. 1, the mobile terminal 100 includes a wireless communication unit 110, a storage unit 120, a touchscreen 130, and a control unit 140. As the components of the mobile terminal 100 shown in FIG. 1 are nonessential to the method of the present invention, a new component may be added or an existing component may be omitted or replaced. For example, when the mobile terminal 100 does not support communication, the wireless communication unit 110 may be omitted.

The wireless communication unit 110 includes one or more modules (not shown) that support wireless communication between the mobile terminal 100 and a wireless communication system or between the mobile terminal 100 and a network to which another mobile terminal is connected. For example, the wireless communication unit 110 may include a mobile communication module, a Wireless Local Area Network (WLAN) module, a short-range communication module, a location identification module, and a broadcast reception module.

The storage unit 120 stores various programs for the mobile terminal 100, such as threshold time data for detecting successive scroll actions.

The touchscreen 130 includes a touch panel 131 and a display panel 132. The touch panel 131 detects a scroll action of the user to perform automatic scrolling. The touch panel 131 is capable of sensing finger touch and/or pen touch. The display panel 132 may be realized using one or more display techniques based on Liquid Crystal Display (LCD) and Organic Light Emitting Diodes (OLED). The display panel 132 may automatically scroll the screen.

The control unit 140 controls the overall operation of the mobile terminal 100. In particular, the control unit 140 displays the screen and performs scrolling according to a scroll action detected on the touch panel 131. When a first scroll action is detected, the control unit 140 scrolls the screen for handling successive scrolling. When a second scroll action is detected immediately after detection of the first scroll action, the control unit 140 analyzes the second scroll action. In other words, when two scroll actions are detected in succession, the control unit 140 examines whether the scroll actions detected in succession are successive scroll actions. If the first scroll action (detected first) and the second scroll action (detected next) have the same direction and the time difference between the first scroll action and the second scroll action is less than or equal to the preset threshold time, the control unit 140 determines that the first scroll action and the second scroll action are successive scroll actions. The threshold time is a time value used to determine whether two scroll actions are successive scroll actions. The threshold time may be set at the time of manufacture or set later by the user. The time difference between the first scroll action and the second scroll action may indicate the time duration from touch-up (end time) for the first scroll action to touch-down (start time) for the second scroll action or the time duration from touch-up (end time) for the first scroll action to touch-up (end time) for the second scroll action.

When the scroll actions detected in succession are successive scroll actions, the control unit 140 may automatically scroll the screen. The scrolling speed may be determined on the basis of the time difference between the scroll actions or movement speed of the scroll actions, or may be set to a default value. The control unit 140 may repeatedly display a screenful of information (e.g., one page for a document or browser, one photograph for gallery) at a time according to the set scrolling speed.

When a scroll stop event is detected during automatic scrolling, the control unit 140 terminates automatic scrolling. A touch gesture or interaction (e.g., touch, double touch, multitouch, flick, tap, or scroll) detected in an automatic scrolling state may serve as a scroll stop event. Thereafter, when scroll actions are detected in succession, the control unit 140 may repeat the above procedure for automatic scrolling.

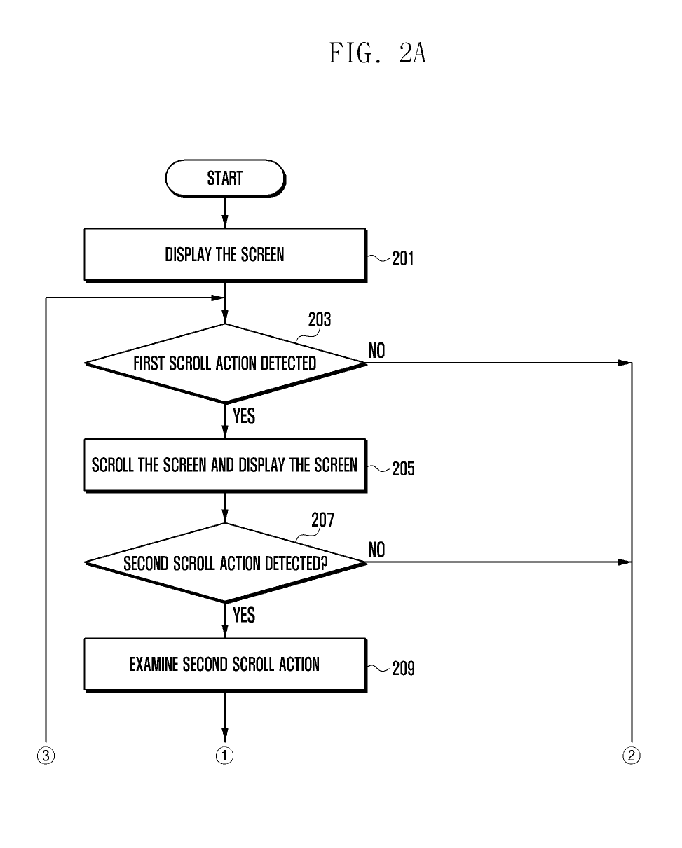

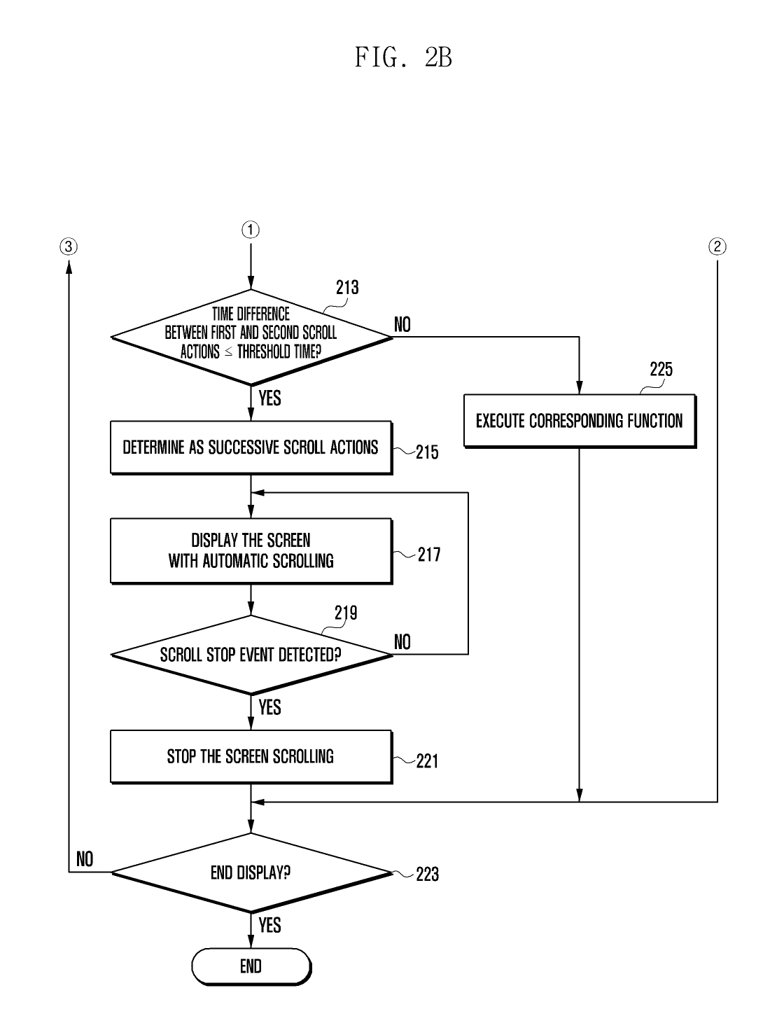

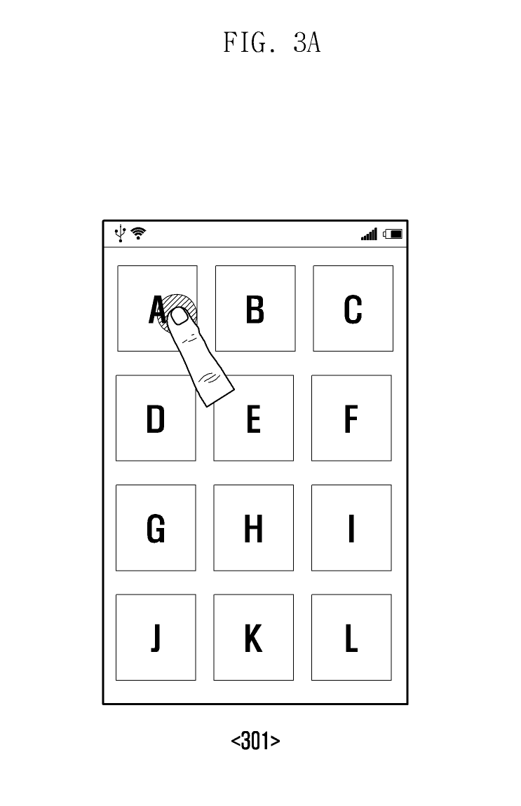

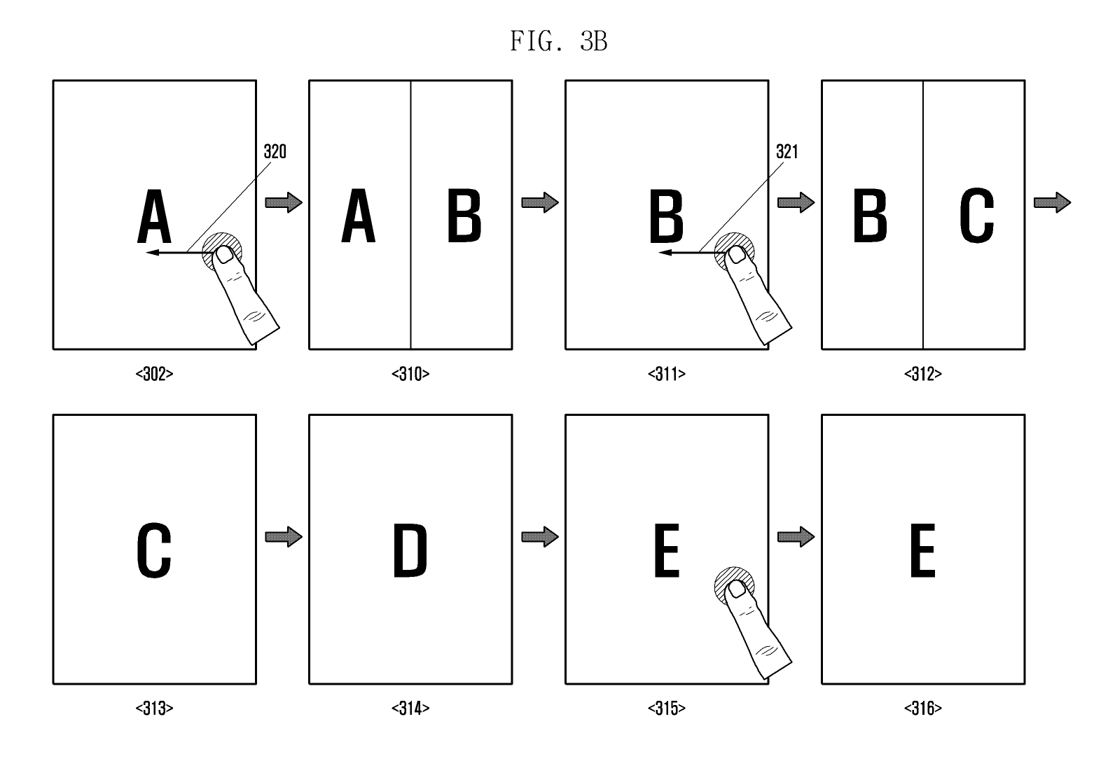

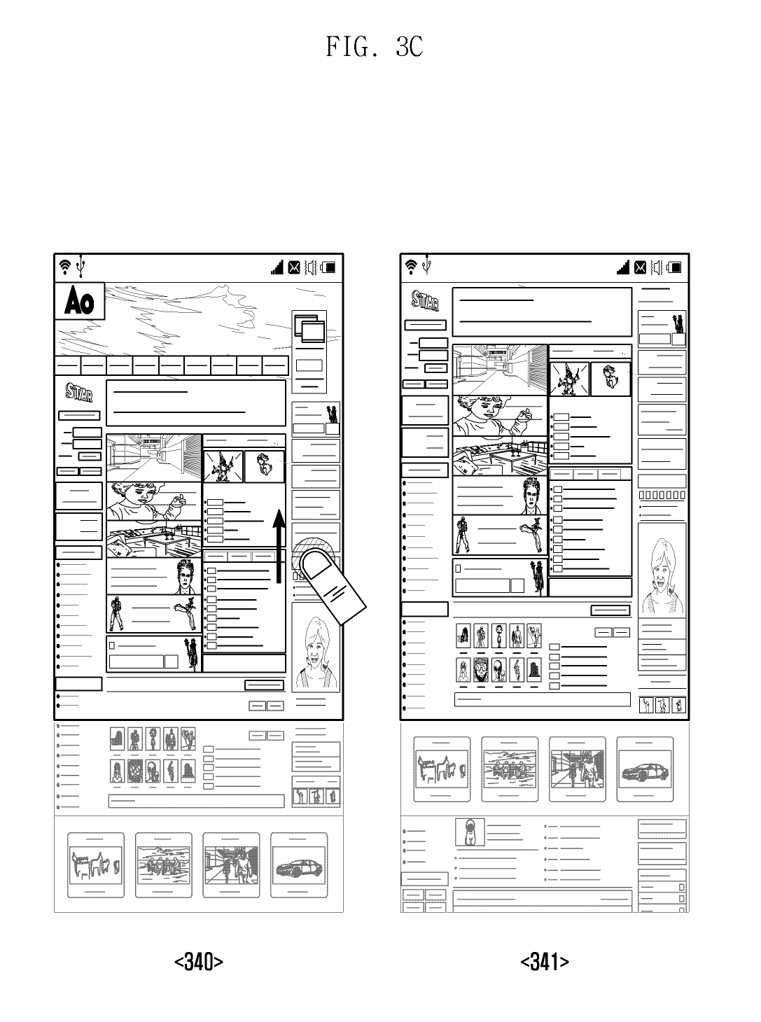

FIGS. 2A and 2B are flowcharts illustrating a procedure for automatic scrolling in the mobile terminal according to an embodiment of the present invention. FIGS. 3A and 3B illustrate automatic scrolling according to the procedure of FIGS. 2A and 2B.

Referring to FIG. 2A, at step 201, the control unit 140 of the mobile terminal displays the screen. The screen data may be execution data of a gallery application composed of multiple images or moving images. For example, an image selected from among stored photographs or moving images represented as thumbnails may be displayed on the screen. During display of the screen, at step 203, the control unit 140 determines whether a first scroll action is detected. If a first scroll action is detected, at step 205, the control unit 140 scrolls and displays the screen according to the first scroll action. At step 207, the control unit 140 determines whether a second scroll action is detected immediately after detection of the first scroll action. If a second scroll action is detected immediately after detection of the first scroll action, at step 209, the control unit 140 examines the second scroll action. The control unit 140 may identify the movement direction, movement speed and movement time of the second scroll action, and compute the time difference between the end time of the first scroll action and the start or end time of the second scroll action. At this time, two or more scroll actions may be detected. In this case, the control unit 140 may regard the most recently detected scroll action as the second scroll action and regard the scroll action detected immediately before the second scroll action as the first scroll action. The control unit 140 may compute the time difference between the end time of the first scroll action and the start time of the second scroll action or between the end time of the first scroll action and the end time of the second scroll action.

Thereafter, referring to FIG. 2B, at step 213, the control unit 140 determines whether the time difference between the first scroll action and the second scroll action is less than or equal to the preset threshold time.

If the direction of the second scroll action is identical to that of the first scroll action and the time difference between the first scroll action and the second scroll action is less than or equal to the threshold time, at step 215, the control unit 140 determines that the first scroll action and the second scroll action are successive scroll actions.

When two or more scroll actions are detected at step 207, the control unit 140 regards the most recently detected scroll action as the second scroll action, regards the scroll action detected immediately before the second scroll action as the first scroll action, and compares the time difference between the first scroll action and the second scroll action with the threshold time. If the computed time difference is less than or equal to the threshold time, the control unit 140 determines that the first scroll action and the second scroll action are successive scroll actions.

Upon determination of successive scroll actions, at step 217, the control unit 140 displays the screen while automatically scrolling the screen at a scrolling speed determined based on the time difference between the first and second scroll actions or movement speed computed using the movement distance and time of, for example, the second scroll action. When multiple scroll actions are detected, the scrolling speed may be set to the average of time differences between scroll actions. The time difference may indicate the difference between the end time of the first scroll action and the start time of the second scroll action or between the end time of the first scroll action and the end time of the second scroll action.

The time difference between scroll actions or the movement time or speed of a scroll action may vary. For example, during execution of a gallery application, when the time difference between scroll actions is 2 seconds, the control unit 140 may repeatedly display a new image (one page for an e-book) at an interval of 2 seconds. The control unit 140 may also repeatedly display a new image (one page for an e-book) at an interval corresponding to the movement speed of a selected scroll action. When multiple scroll actions are detected, the scrolling speed may be set to one of time differences between scroll actions or to the average of time differences between scroll actions. The scrolling speed may also be set to the movement speed of one scroll action or to the average of movement speeds of scroll actions.

During automatic scrolling, at step 219, the control unit 140 determines whether a scroll stop event is detected. A scroll stop event may be a touch gesture, such as touch, double touch, multitouch, flick, tap or scroll, on the touch panel 131. If a scroll stop event is detected, at step 221, the control unit 140 stops automatic scrolling. Thereafter, at step 223, the control unit 140 determines whether an end display event is detected. If an end display event is detected, the process ends, and if the end display event is not detected, the control unit 140 returns to step 203 and repeats the above procedure. At step 225, the controller 140 executes corresponding function.

Later, when successive scroll actions are newly detected, the control unit 140 may set a new scrolling speed for automatic scrolling. The new scrolling speed may be determined based on the time difference between scroll actions or the movement speed of one scroll action computed using the movement distance and time.

FIG. 3A illustrates a screen representation wherein an image selected from among stored images or moving images presented as thumbnails is displayed on the screen. As indicated by reference numeral 301, multiple images or moving images are presented as thumbnails. Upon selection of image A as indicated by reference numeral 301, the control unit 140 displays image A in a full screen format as indicated by reference numeral 302 in FIG. 3B (step 201). As indicated by reference numeral 302 when a first scroll action 320 in a direction from right to left is detected (step 203), the control unit 140 scrolls and displays the screen according to the first scroll action (step 205). Image A and image B may be displayed simultaneously as indicated by reference numeral 310 during right-to-left scrolling, and image B may be displayed in a full screen format after scrolling as indicated by reference numeral 311. As indicated by reference numeral 311, the control unit 140 may detect a second scroll action 321 in a direction from right to left (step 207). The control unit 140 examines the second scroll action (step 209). Specifically, the control unit 140 determines whether the time difference between the first scroll action and the second scroll action is less than or equal to the preset threshold time (step 213). If the time difference between the first scroll action and the second scroll action is less than or equal to the threshold time, the control unit 140 determines that the first scroll action and the second scroll action are successive scroll actions (step 215). Upon determination of successive scroll actions, the control unit 140 displays the screen while automatically scrolling the screen at a scrolling speed determined based on the time difference between the first and second scroll actions or a movement speed computed using the movement distance and time of, for example, the second scroll action (step 217).

During automatic scrolling, different images may be displayed in succession at the set scrolling speed: image B and image C as indicated by reference numeral 312, image C as indicated by reference numeral 313, image D as indicated by reference numeral 314, and image E as indicated by reference numeral 315. That is, the control unit 140 automatically scrolls the screen at the determined scrolling speed. As indicated by reference numeral 315 where image E is displayed as a result of automatic scrolling, the control unit 140 may detect a scroll stop event (step 219). Then, the control unit 140 stops automatic scrolling (step 221) with display of image E as indicated by reference numeral 316. The above procedure may be repeated with a new scrolling speed.

Referring to FIG. 3C, reference numeral 340 indicates a state in which a first scroll action is detected first and a second scroll action is detected during execution of an Internet application. As display data of the Internet application does not fit within the screen, upon detection of a scroll action, the control unit 140 brings corresponding content into view on the screen. When a second scroll action is detected in the state indicated by reference numeral 340, the control unit 140 automatically scrolls the screen with a sliding effect according to the direction and speed of the second scroll action as indicated by reference numeral 341. Specifically, if the time difference between the first scroll action and the second scroll action is less than or equal to the preset threshold time, the control unit 140 determines that the first scroll action and the second scroll action are successive scroll actions. When the scroll actions detected in succession are successive scroll actions, the control unit 140 may automatically scroll the screen at a scrolling speed determined based on the time difference between scroll actions or the movement speed of one scroll action computed using the movement distance and time.

As described above, when a first scroll action is detected on the screen, the control unit 140 scrolls the screen accordingly. When a second scroll action is detected immediately after the first scroll action, the control unit 140 analyzes the second scroll action. If the direction of the second scroll action is identical to that of the first scroll action and the time difference between the first scroll action and the second scroll action is less than or equal to the threshold time, the control unit 140 determines that the first scroll action and the second scroll action are successive scroll actions. If the direction of the second scroll action is not identical to that of the first scroll action, the control unit 140 determines that the first scroll action and the second scroll action are not successive scroll actions and stops scrolling. The control unit 140 determines the scrolling speed on the basis of the time difference between the scroll actions or the movement speed of a scroll action computed using the movement distance and time. When multiple scroll actions are detected, the control unit 140 compares the time difference between the scroll actions with the threshold time and determines that the scroll actions are successive scroll actions if the time difference is less than or equal to the threshold time. The control unit 140 determines the scrolling speed on the basis of the average of movement distances of scroll actions and the average of movement times of the scroll actions. The control unit 140 may also set the scrolling speed to the average of time differences between scroll actions. Thereafter, the control unit 140 may automatically scroll the screen at the set scrolling speed.

When a scroll stop event is detected during automatic scrolling, the control unit 140 stops automatic scrolling. Later, when successive scroll actions are newly detected, the control unit 140 may set a new scrolling speed for automatic scrolling in a manner described above. Hence, the control unit 140 may increase or decrease the scrolling speed for automatic scrolling.

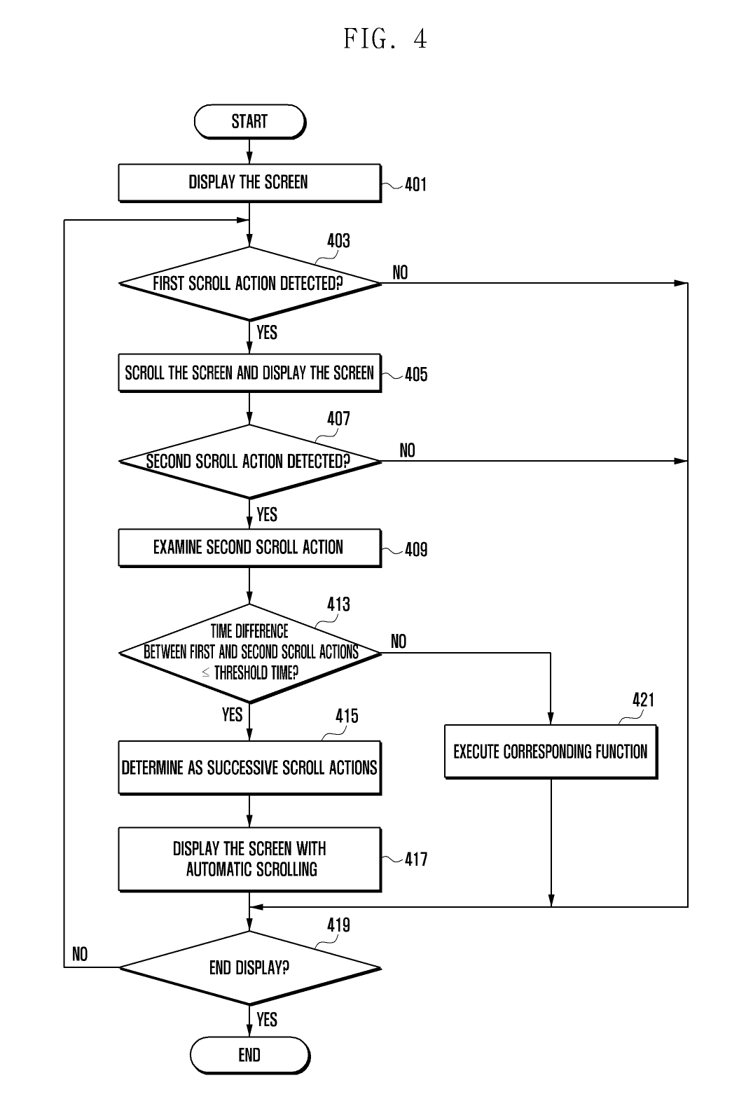

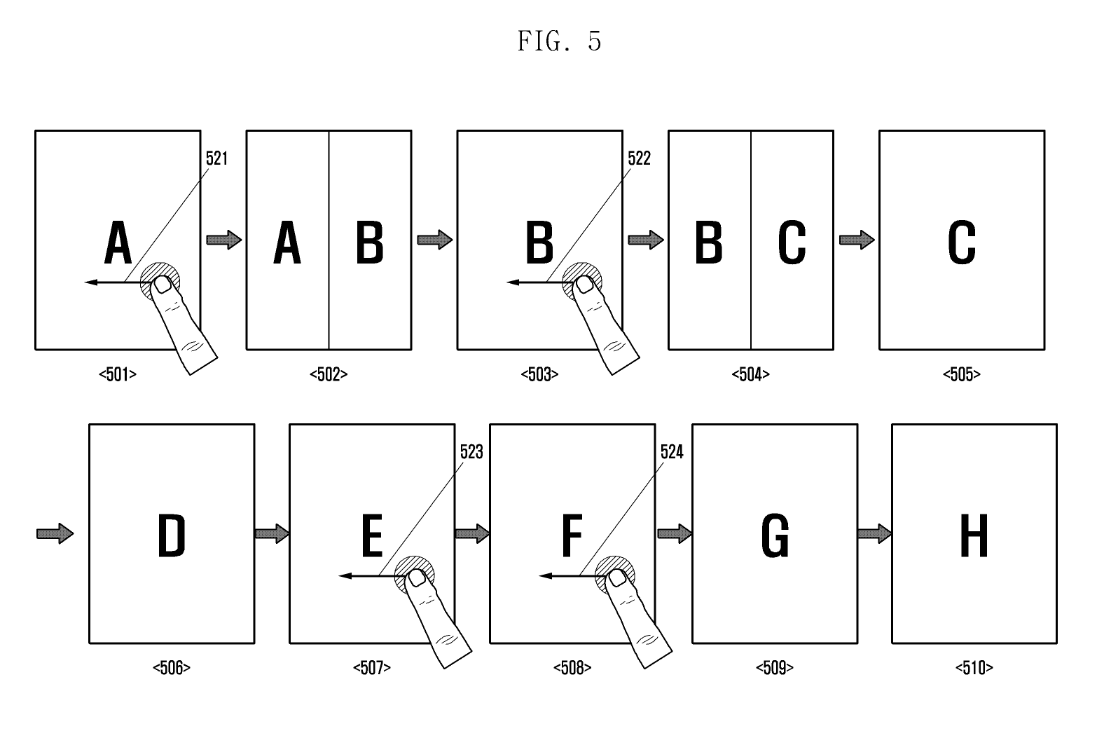

FIG. 4 is a flowchart illustrating a procedure for automatic scrolling in the mobile terminal according to another embodiment of the present invention. FIG. 5 illustrates automatic scrolling in the mobile terminal according to the procedure of FIG. 4.

Referring to FIG. 4, steps 401 to 417 of FIG. 4 are identical respectively to steps 201 to 217 of FIG. 2, and thus, a description thereof is omitted.

During automatic scrolling, at step 419, the control unit 140 determines whether an end display event is detected. If an end display event is not detected, the control unit 140 returns to step 403 and repeats the above procedure. Later, when successive scroll actions are newly detected, the control unit 140 may set a new scrolling speed for automatic scrolling. The new scrolling speed may be determined based on the time difference between scroll actions or the movement speed of one scroll action computed using the movement distance and time. The control unit 140 performs automatic scrolling at the computed scrolling speed. When the last image or page is displayed, the control unit 140 ends automatic scrolling.

In FIG. 5, as indicated by reference numeral 501, upon selection of image A from among multiple images presented as thumbnails, image A is displayed in a full screen format (step 401). As indicated by reference numeral 501, when a first scroll action 521 in a direction from right to left is detected (step 403), the control unit 140 scrolls the screen according to the first scroll action (step 405). Image A and image B are displayed simultaneously as indicated by reference numeral 502 during right-to-left scrolling, and image B is displayed in a full screen format after scrolling as indicated by reference numeral 503. As indicated by reference numeral 503, when a second scroll action 522 in a direction from right to left is detected (step 407), the control unit 140 scrolls the screen according to the second scroll action. Image B and image C are displayed simultaneously as indicated by reference numeral 504 during right-to-left scrolling, and image C is displayed in a full screen format after scrolling as indicated by reference numeral 505.

In addition, the control unit 140 examines the second scroll action (step 409). Specifically, the control unit 140 determines whether the time difference between the first scroll action and the second scroll action is less than or equal to the preset threshold time (step 413). Controller 140 executes corresponding function (step 421). If the time difference between the first scroll action and the second scroll action is less than or equal to the threshold time, the control unit 140 determines that the first scroll action and the second scroll action are successive scroll actions (step 415). Upon determination of successive scroll actions, the control unit 140 displays the screen while automatically scrolling the screen at a scrolling speed determined based on the time difference between the first and second scroll actions or a movement speed computed using the movement distance and time of, for example, the second scroll action (step 417).

For example, during automatic scrolling, different images may be displayed in succession at the set scrolling speed (e.g., at an interval of 2 seconds): image C as indicated by reference numeral 505, image D as indicated by reference numeral 506, and image E as indicated by reference numeral 507. That is, the control unit 140 automatically scrolls the screen by displaying different images at an interval of, for example, 2 seconds. Thereafter, as indicated by reference numeral 507, when a first scroll action 523 in a direction from right to left is newly detected (step 403), the control unit 140 scrolls the screen according to the first scroll action (step 405). As a result, image F is displayed after scrolling as indicated by reference numeral 508. In reference numeral 508, when a second scroll action 524 in a direction from right to left is newly detected (step 407), the control unit 140 scrolls the screen according to the second scroll action. As a result, image G is displayed after scrolling as indicated by reference numeral 509. In addition, the control unit 140 examines the second scroll action (step 409). If the direction of the second scroll action is identical to that of the first scroll action and the time difference between the first scroll action and the second scroll action is less than or equal to the threshold time, the control unit 140 determines that the first scroll action and the second scroll action are successive scroll actions (step 415). For example, the time difference between the first scroll action and the second scroll action may be 1 second. The control unit 140 displays the screen while automatically scrolling the screen at a scrolling speed (e.g., at an interval of 1 second) determined based on the time difference between the first and second scroll actions or a movement speed computed using the movement distance and time of, for example, the second scroll action (step 417). For example, during automatic scrolling, different images may be displayed in succession at the set scrolling speed (e.g., at an interval of 1 second): image G as indicated by reference numeral 509, and image H as indicated by reference numeral 510. Automatic scrolling may be continued at the newly set scrolling speed.

As described above, when a first scroll action and a second scroll action are detected during display of the screen, the control unit 140 analyzes the second scroll action. If the direction of the second scroll action is identical to that of the first scroll action and the time difference between the first scroll action and the second scroll action is less than or equal to the threshold time, the control unit 140 determines that the first scroll action and the second scroll action are successive scroll actions. The control unit 140 determines the scrolling speed on the basis of the time difference between the scroll actions or the movement speed of a scroll action computed using the movement distance and time. Thereafter, the control unit 140 performs automatic scrolling at the determined scrolling speed. When a first scroll action and second scroll action are newly detected, the control unit 140 determines a new scrolling speed for automatic scrolling according to the procedure described above and perform automatic scrolling at the new scrolling speed. Hence, the scrolling speed may be varied during automatic scrolling.

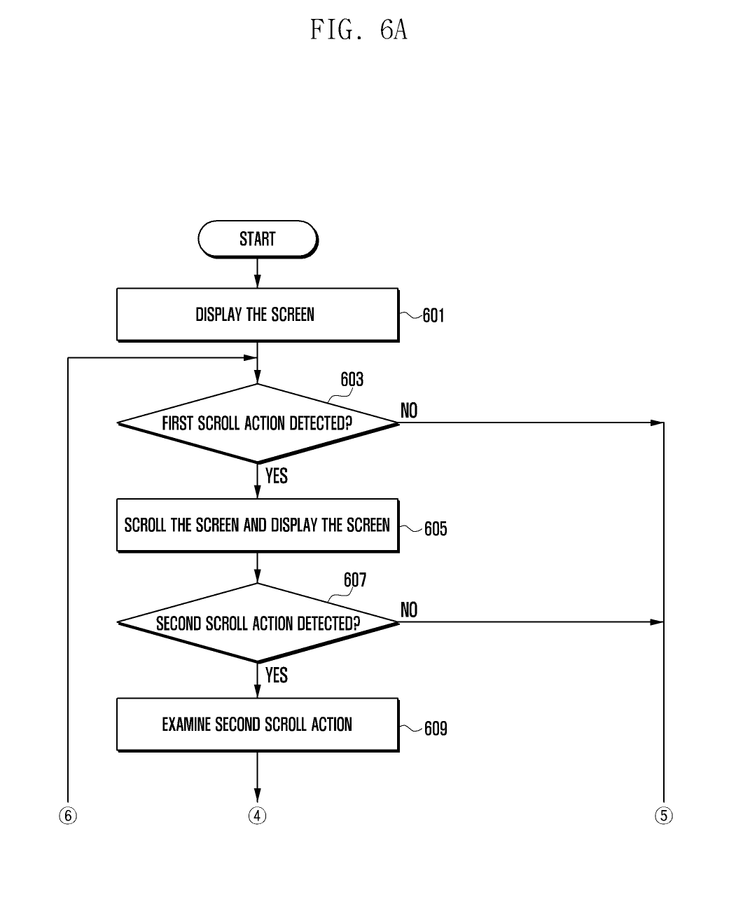

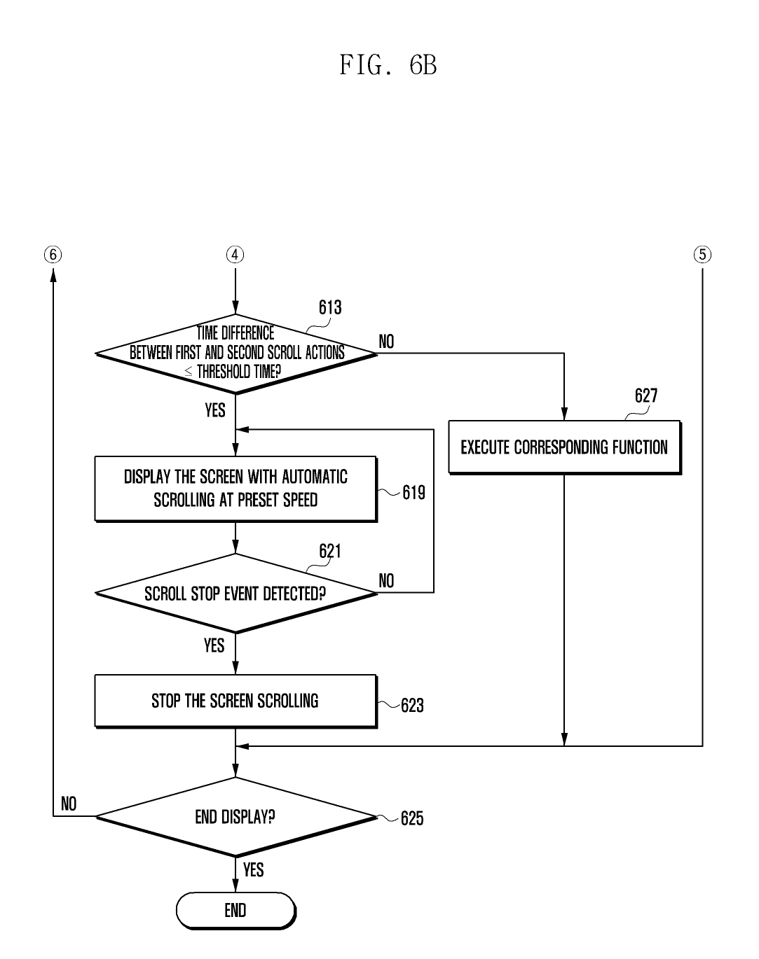

FIGS. 6A and 6B are flowcharts illustrating a procedure for automatic scrolling in the mobile terminal according to another embodiment of the present invention.

Referring to FIG. 6A, at step 601, the control unit 140 of the mobile terminal displays the screen. At step 603, the control unit 140 determines whether a first scroll action is detected. If a first scroll action is detected, at step 605, the control unit 140 scrolls and displays the screen according to the first scroll action. Scrolling is performed at a preset scrolling speed in a direction indicated by the first scroll action. If a scroll action is not detected, the display ends. At step 607, the control unit 140 determines whether a second scroll action is detected immediately after the first scroll action. If a second scroll action is detected immediately after the first scroll action, at step 609, the control unit 140 examines the second scroll action. If a second scroll action is not detected, the display ends. Specifically, referring to FIG. 6B, at step 613, the control unit 140 determines whether the time difference between the first scroll action and the second scroll action is less than or equal to the preset threshold time.

If the time difference between the first scroll action and the second scroll action is less than or equal to the threshold time, at step 619, the control unit 140 determines that the first scroll action and the second scroll action are successive scroll actions and displays the screen while automatically scrolling the screen at a preset interval. The threshold time is a time value used to determine whether two scroll actions are successive scroll actions. The threshold time may be set at the time of manufacture or set later by the user if necessary.

During automatic scrolling, at step 621, the control unit 140 determines whether a scroll stop event is detected. A scroll stop event may be a touch gesture such as touch, double touch, multitouch, flick, tap or drag. If a scroll stop event is not detected, the control unit 140 returns to step 619 and continues automatic scrolling. When the last page is displayed, the control unit 140 stops automatic scrolling. If a scroll stop event is detected, at step 623, the control unit 140 stops automatic scrolling. Thereafter, at step 625, the control unit 140 determines whether a display end event is detected. If a display end event is not detected, the control unit 140 returns to step 603 and repeats the above procedure. At step 627, the controller 140 executes corresponding function.

As described above, when a first scroll action is detected on the screen after the threshold time is set for successive scrolling, the control unit 140 scrolls the screen accordingly. The screen is displayed after being scrolled in accordance with the direction and speed of the first scroll action. When a second scroll action is detected immediately after the first scroll action, the control unit 140 analyzes the second scroll action. The control unit 140 may identify the direction of the second scroll action, time difference between the first scroll action and second scroll action, and movement distance and time of the second scroll action. If the direction of the second scroll action is identical to that of the first scroll action and the time difference between the first scroll action and the second scroll action is less than or equal to the threshold time, the control unit 140 determines that the first scroll action and the second scroll action are successive scroll actions. If the speed corresponding to the time difference between the first scroll action and the second scroll action is greater than or equal to a preset threshold speed, the control unit 140 determines that the first scroll action and the second scroll action are successive scroll actions. Upon determination of successive scroll actions, the control unit 140 displays the screen while automatically scrolling the screen at a determined scrolling speed.

When a scroll stop event is detected during automatic scrolling, the control unit 140 ends automatic scrolling. When the last page or image is displayed through automatic scrolling, the control unit 140 ends automatic scrolling. Later, when first and second scroll actions are newly detected, the control unit 140 repeats the above procedure.

Hereinabove, embodiments of the present invention have been shown and described for the purpose of illustration without limiting the subject matter of the present invention. It should be understood by those skilled in the art that many variations and modifications of the method and apparatus described herein will still fall within the spirit and scope of the present invention as defined in the appended claims and their equivalents.

What is claimed is:

1. A scrolling control method for a mobile terminal, comprising:
displaying a screen;
measuring, when a first scroll action and a second scroll action are detected in succession on the screen, a time difference between the first scroll action and second scroll action;
determining successive scroll actions when the time difference is less than or equal to a preset threshold time; and
performing, upon determination of the successive scroll actions, automatic scrolling by displaying the screen while scrolling the screen.

2. The scrolling control method of claim 1, wherein the threshold time is a value used to determine whether two scroll actions are successive scroll actions and is preset or set by a user.

3. The scrolling control method of claim 2, wherein, when two or more scroll actions are detected, the most recently detected scroll action is regarded as the second scroll action and the scroll action detected immediately before the second scroll action is regarded as the first scroll action.

4. The scrolling control method of claim 3, wherein, when two or more scroll actions are detected, a scrolling speed is set to one of time differences between the scroll actions or a speed computed using a movement distance and time of a selected scroll action.

5. The scrolling control method of claim 1, further comprising setting, upon determination of successive scroll actions, a scrolling speed corresponding to the time difference.

6. The scrolling control method of claim 5, wherein setting the scrolling speed comprises computing the scrolling speed according to the time difference between the first scroll action and second scroll action.

7. The scrolling control method of claim 5, wherein setting the scrolling speed comprises computing the scrolling speed according to the movement distance and time of at least one of the first scroll action and second scroll action.

8. The scrolling control method of claim 7, wherein computing the scrolling speed comprises at least one of calculating the scrolling speed based on the movement distance and time of the first scroll action, calculating the scrolling speed based on the movement distance and time of the second scroll action, and calculating the scrolling speed on the basis of the average movement distance and average movement time of the first scroll action and second scroll action.

9. The scrolling control method of claim 5, wherein performing automatic scrolling comprises at least one of:
scrolling the screen at the set scrolling speed,
stopping automatic scrolling when a preset scroll stop event is detected,
stopping automatic scrolling when a last page is displayed, and
resetting, when first and second scroll actions are newly detected, the scrolling speed according to the newly detected scroll actions.

10. The scrolling control method of claim 1, wherein determining that the first scroll action and the second scroll action are successive scroll actions further comprises:
measuring, when two or more scroll actions are detected, at least one time difference between the detected scroll actions;
configuring automatic scrolling when the time difference is less than the threshold time; and
setting a scrolling speed to an average of the at least one time difference between the detected scroll actions.

11. A scrolling control apparatus for a mobile terminal, comprising:
a display panel that displays screen data;
a touch panel that detects a first scroll action and a second scroll action in succession on the screen; and
a control unit that controls a process of measuring time difference between the first scroll action and second scroll action, determines that the first scroll action and the second scroll action are successive scroll actions when the time difference is less than or equal to a preset threshold time, and performs, upon determination of successive scroll actions, automatic scrolling by displaying the screen while scrolling the screen.

12. The scrolling control apparatus of claim 11, wherein the control unit further sets a scrolling speed for automatic scrolling according to the time difference between the first scroll action and second scroll action.

13. The scrolling control apparatus of claim 11, wherein the control unit further sets a scrolling speed for automatic scrolling according to a movement distance and time of at least one of the first scroll action and second scroll action.

14. The scrolling control apparatus of claim 11, wherein the control unit further stops automatic scrolling when a preset scroll stop event is detected or a last page is displayed.

15. The scrolling control apparatus of claim 11, wherein, when first and second scroll actions are newly detected, the control unit resets the scrolling speed according to the newly detected scroll actions.

16. The scrolling control apparatus of claim 11, wherein, when two or more scroll actions are detected, the control unit regards a most recently detected scroll action as the second scroll action and regards a scroll action detected immediately before the second scroll action as the first scroll action.

17. The scrolling control apparatus of claim 11, wherein, when two or more scroll actions are detected, the control unit sets a scrolling speed for automatic scrolling to one of time differences between the scroll actions or to a speed computed using a movement distance and time of at least one scroll action.

18. The scrolling control apparatus of claim 11, wherein, when two or more scroll actions are detected, the control unit measures at least one time difference between the detected scroll actions, configures automatic scrolling when the time difference is less than the threshold time, and sets a scrolling speed to the average of the time differences between the detected scroll actions.

19. The scrolling control apparatus of claim 18, wherein, when two or more scroll actions are detected, the control unit computes the average movement speed of the detected scroll actions and sets a scrolling speed for automatic scrolling to the average movement speed.

20. The scrolling control apparatus of claim 11, wherein the threshold time is preset at a time of manufacture or reset at a time of user configuration.
